(19) United States
(12) Patent Application Publication
(10) Pub. No.: US 2007/0261718 A1
(43) Pub. Date: Nov. 15, 2007

(54) Method and apparatus for ozone-enhanced cleaning of flat objects with pulsed liquid jet

(76) Inventor: Rubinder Randhawa, Dublin, CA (US)

Correspondence Address: Rubinder S. Randhawa;Planar Semiconductor, Inc., 47697 Westinghouse Drive # 100, Fremont, CA, 94539, US

(21) Appl. No.: 11/431,879

(22) Filed: May 10, 2006

(51) Int. Cl. B08B 3/00; B08B 3/12; B08B 6/00

(52) U.S. Cl. 134/34; 134/198

(57) ABSTRACT

The invention provides an apparatus and a method for cleaning semiconductor wafers in a wet cleaning process with the use of pulsed liquid jets. The apparatus contains a source of an ozonated cleaning solution impinged through nozzles onto the surface of a vertically arranged semiconductor wafer, or a similar object, in the form of a series of pulses that may be alternated with pulses of overheated cleaning steam-and-water mixture, hot gas, and optionally, of deionized water, emitted through respective individual nozzles. The ozonated cleaning water solution has a temperature of about 5° C., the overheated steam-and-water mixture is supplied at a temperature of about 200° C., and the pulse of the hot gas heated to about 100° C. follows the cold ozonated solution pulse in order to compensate for an abrupt temperature change between the cold solution pulse and the overheated steam-and-water mixture pulse.

### CROSS-REFERENCES TO RELATED APPLICATIONS

The present patent application is related to U.S. patent application Ser. No. 269,250 filed by R. S. Randhawa on Nov. 9, 2005, entitled “Apparatus and Method for Cleaning Flat Objects in a Vertical Orientation with Pulsed Liquid Jet” and to U.S. patent application Ser. No. 299,134 filed by R. S. Randhawa on Dec. 12, 2005 entitled “Method and Apparatus for Cleaning Flat Objects with Pulsed Liquid Jet”.

### FIELD OF THE INVENTION

The present invention relates to the field of cleaning flat objects, in particular to wet cleaning of semiconductor wafers during production. More specifically, the invention relates to an apparatus and a method for cleaning semiconductor wafers in a wet cleaning process with the use of pulsed liquid jets.

### DESCRIPTION OF THE PRIOR ART

Cleaning of surfaces of wafer substrates is one of the most important steps in the fabrication of semiconductor microelectronic devices. It is well known that the presence of chemical contaminants and particles of impurities may significantly reduce product yield and noticeably affect the performance and reliability of the produced semiconductor devices.

In view of the present trend in the semiconductor industry that goes far beyond features such as submicron sizes, the effective techniques for cleaning silicon wafers, e.g., initially and after oxidation and patterning, are now more important than ever before because of the extreme sensitivity of semiconductor surfaces to the presence of contaminants. Specifically, total metallic impurities should be far less than 10¹⁰ atoms per cm². Presence of particles larger than 0.1 μm in size should be much less than approximately 0.1 per cm².

In view of the fact that the above criteria are very stringent, the efficiency of the equipment and processes used for wafer cleaning should be evaluated from the point of view of satisfaction of the above requirements in the treated wafers.

There exists a plurality of various methods and processes for wafer cleaning that roughly can be subdivided into dry-physical, wet-physical, combined wet physical/chemical, vapor-phase methods, etc. Furthermore, there exists a series of apparatuses for implementing the aforementioned cleaning processes in the industry.

In a majority of cases, the cleaning processes are oriented specifically on silicon since this material is a basis for fabrication of integrated circuits.

The present invention pertains to the aforementioned wet-physical and combined wet physical/chemical processes, which are the most widely used processes for the cleaning of semiconductor wafers. The wet cleaning methods and apparatuses, in turn, have a plurality of different implementations with vertical or horizontal orientation of single or multiple wafers performing different specific movements during the cleaning cycle, the use of different cleaning media and tools, the use of different methods for drying, etc.

Attempts have been made to apply a new approach to the wafer-cleaning problem. An example of such an approach is the development of a rapid-pulse harmonic spray technology developed by the applicant and described by Mehran Janani, et al., in the article “A novel approach to metal lift-off for GaAs ICs” (see the Internet address: (http://www.compoundsemiconductor.net/articles/magazine/9/10/3/1).

The fluid droplets in each pulse interact with the wafer, which rotates slowly in a vertical orientation, to produce a hybrid of laminar and turbulent flow types. Rapid pulsing controls the fluid-mechanical interactions of jets and droplets with adsorbed contaminants. As a result, the chemical concentration gradient at the wafer/liquid interface is always positioned to favor desorption of contaminants. The moderate application of a pressurized solvent allows for a blend of mechanical and chemical energy for lift-off applications. Large particles are removed at the point of impact of the pulse spray due to the generation of turbulent flow. In the laminar flow regime, wherein the boundary layer is less than 1 μm, the solvent is responsible for dispersing and rinsing small particles and labile layer removal. Compared with other technologies that use fluids at super-critical pressures aided with co-solvents, dry CO₂/liquid approaches, and jet sprays, the rapid-pulse approach manipulates all of the essential thermal, mechanical, and chemical ingredients for effective cleaning, thereby offering a simple, elegant and cost-effective solution.

Although the above-described rapid-pulse harmonic spray method and apparatus have considerably improved efficiency of cleaning, they are still insufficiently effective for removing contaminant particles having dimensions of 0.1 μm or less.

In order to eliminate the above disadvantage of known rapid-pulse harmonic spray systems, the applicant has developed nozzles with special means for enhancing formation of medium droplets. This improved technique is disclosed in

U.S. patent application Ser. No. 299,134 filed by the applicant, R. S. Randhawa, on Dec. 12, 2005. In various embodiments of the aforementioned invention, the droplet-formation enhancement means are located inside the nozzle at the nozzle outlet end and are made in the form of a jet splitter, threaded grooves on the inner surface of the nozzle body, or in the form of a thin tube for the supply of gas into the flow of the liquid cleaning medium for the formation of gas bubbles in the medium. The method and the apparatus are based on the principle that the use of the aforementioned droplet-formation enhancement means increases the boundary surface between the liquid medium and the surrounding gaseous atmosphere and thus produces an increased amount of droplets. The efficiency of the cleaning operation is improved by combining the aforementioned controlled droplet-formation mechanism with a pulsed nature of the emitted jet. The method also takes into account such factors as mass ratio between the droplets and the contaminant particles, velocity of droplets, organization and sequence of jets that attack the surface of the wafer and flows that wash-out the separated particles, etc.

The cleaning unit of U.S. patent application Ser. No. 299,134 is intended for operation in a closed cleaning chamber located preferably in a pure and controllable environment. The unit contains a stationary nozzle array composed of a plurality of the aforementioned nozzles that may be positioned on both sides of the vertically oriented objects, e.g., a semiconductor wafer, for cleaning the front and back surfaces of the wafer simultaneously. The nozzles operate in a rapid-pulse harmonic spray mode with the formation of pulsed fluid streams of discrete droplets injected onto the wafer surface. The droplets have a specific size that matches the size and type of the contaminant particles. The jets are created by means of an electrical three-diaphragm short piston pump (not shown) and may be combined with specially selected chemistry. The apparatus may be provided with reservoirs for different cleaning media and with a heater and a cooler for heating and cooling of cleaning liquids with reference to the used chemicals and other operational conditions. Rapid-pulsed streams of chemical and cleaning liquids are fired in timed succession controlled from a central processing unit. Some embodiments provide the use of additional laminar-flow nozzles for removal of the contaminant particles separated by turbulent pulsed streams. The pulsed jet cleaning liquid and the washing liquid can be supplied at different temperatures selected with reference to specific operational requirements. However, the above-described method and apparatus are based on improvement of purely mechanical means of wafer cleaning and do not improve removal of organic components of the wafer contaminants.

On the other hand, it is known that ozone is a strong oxidizer, and systems exist that remove contaminants, especially organic contaminants and photoresist film residuals from the surfaces of semiconductor wafer substrates with the use of gaseous ozone. The contaminant removal property of ozone is based on the fact that ozone decomposes complex organic compounds into volatile and water-soluble components.

For example, the oxidizer may be H₂SO₄, H₂O₂, as well as some mixtures based on alkalized compounds depending on the type of resist. Beginning in 1988, when a patent was defended based on resist stripping by dilution of ozone with water, many “wet” processing processes were developed. FIG. 1 gives the temperature effect of ozone dilution where the Benzene coefficient (k) gives the concentration of ozone in gas and in water. It is noticed that the optimal condition is provided when the temperature is about 5° C. At this temperature, concentration of ozone in water is three or more time higher than at r5oom temperature.

Unlike other “wet” processes, photoresist removal in aqueous solutions of ozone takes place in several stages:

1. In the beginning the ozone introduces ozonides chains into the polymer matrix on the surface of the photoresist.

2. Ozonides are then created simultaneously, resulting in destruction of polymer as indicated by the following chemical equation:

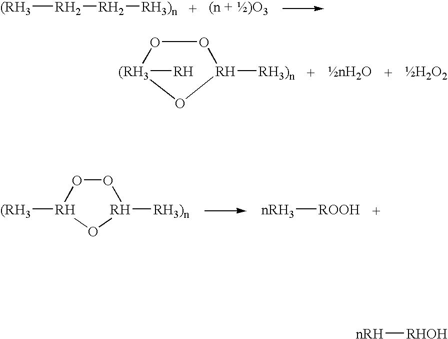

3. The final stage forms organic acids, solvents and other gaseous byproducts easily dissolved in water and then removed from the wafer surface by water flow.

The advantage of the photoresist removal method is the high degree of ecological purity of process, because polluting chemical reagents are absent.

For example, H₂SO₄, alkaline and H₂O₂ are not present. The photoresist is uniformly removed from all surfaces without stratification and without the formation of polymer strings. Such stripping technology allows removal of other surface residues, such as sulfides and other surface materials.

A disadvantage of this method is the low speed of the oxidation process, and consequently, photoresist removal. Because this is a “wet” process, one must consider how the wafers are to be rinsed and dried.

Ozone-based cleaning systems can be roughly divided into systems wherein cleaning is carried out with ozone in a gaseous form (clean air with O₃) and systems wherein ozone is used in solutions, predominantly in aqueous solutions. Also known are cleaning systems wherein ozone is generated directly in oxygen or in mixtures of oxygen with rare gas (plasma methods).

Given below are some examples of applying the ozone-based cleaning systems mentioned above in the semiconductor manufacturing industry, e.g., for resist-stripping operations where ozone is used due to its high efficiency in removing organic substances.

U.S. Pat. No. 6,851,873 issued in 2005 to H. Maruoka, et al., describes a method and an apparatus for removing an organic film, such as a resist film, from a substrate surface. The apparatus uses a treatment liquid that contains dissolved ozone and preferably is formed from liquid ethylene or propylene carbonate, or both, that is brought in contact with the substrate having an organic film. The apparatus contains a treatment liquid delivery device, a film contact device, a liquid circulation device, and an ozone dissolution device.

U.S. Pat. No. 6,863,836 issued in Mar. 8, 2005 to R. Novak, et al., discloses a method of removing photoresist from semiconductor wafers through the use of a sparger plate. According to the method, at least one semiconductor wafer is positioned in a process tank above the sparger plate. A mixture of ozone and deionized water is introduced into the process tank at a position below the sparger plate. The mixture of ozone and deionized water is then introduced across the wafer via the sparger plate at an increased flow velocity while the wafer is submerged in the mixture of deionized water and ozone. A sparger plate is a perforated plate used for spreading and distributing gas.

U.S. Pat. No. 6,701,941 issued in 2004 to Eric Bergman discloses an apparatus for supplying a mixture of a treatment liquid and ozone for treatment of the surface of a workpiece, and a corresponding method was set forth. The preferred embodiment of the apparatus comprises a liquid supply line that is used to provide fluid communication between a reservoir containing the treatment liquid and a treatment chamber housing the workpiece. A heater is disposed to heat the workpiece, either directly or indirectly. Preferably, the workpiece is heated by heating the treatment liquid that is supplied to the workpiece. One or more nozzles accepts the treatment liquid from the liquid supply line and sprays it onto the surface of the workpiece while an ozone generator provides ozone into an environment containing the workpiece.

U.S. Pat. No. 6,837,252 issued in 2005 to Eric Bergman describes a method for processing a workpiece to remove material from the first surface of the workpiece, wherein steam is introduced onto the first surface so that at least some of the steam condenses and forms a liquid boundary layer on the first surface. The condensing steam helps to maintain the first surface of the workpiece at an elevated temperature. Ozone is provided around the workpiece when the ozone diffuses through the boundary layer and reacts with the material on the first surface. The temperature of the first surface is controlled to maintain condensation of the steam.

U.S. Pat. No. 6,830,628 issued in 2004 to Eric Bergman discloses methods for cleaning surfaces of wafers or other semiconductor articles. Oxidizing is performed using an oxidation solution which is wetted onto the surface. The oxidation solution can include one or more of: water, ozone, hydrogen chloride, sulfuric acid, or hydrogen peroxide. A rinsing step removes the oxidation solution and inhibits further activity. The rinsed surface is thereafter preferably subjected to a drying step. The surface is exposed to an oxide removal vapor to remove semiconductor oxide therefrom. The oxide removal vapor can include one or more of: acids, such as a hydrogen halide, example of which is hydrogen fluoride or hydrogen chloride; water; isopropyl alcohol; or ozone. The processes can use centrifugal processing and spraying actions.

U.S. Pat. No. 6,817,370 issued in 2004 to Eric Bergman, et al., relates to an apparatus and a method for supplying a mixture of a treatment liquid and ozone for treatment of the surface of a workpiece. The preferred embodiment of the apparatus comprises a liquid supply line that is used to provide fluid communication between a reservoir containing the treatment liquid and a treatment chamber housing the workpiece. A heater is disposed to heat the workpiece, either directly or indirectly. Preferably, the workpiece is heated by heating the treatment liquid that is supplied to the workpiece. One or more nozzles accepts the treatment liquid from the liquid supply line and sprays it onto the surface of the workpiece while an ozone generator provides ozone into an environment containing the workpiece.

U.S. Pat. No. 6,869,487 issued in 2005 to Eric Bergman discloses a novel chemistry, system, and application technique for reducing contamination of semiconductor wafers and similar substrates. A stream of liquid chemical is applied to the workpiece surface. Ozone is delivered either into the liquid process stream or into the process environment. The ozone is generated preferably by a high-capacity ozone generator. The chemical stream is provided in the form of a liquid or vapor. A boundary layer liquid or vapor forms on the workpiece surface. The thickness of the boundary layer is controlled. The chemical stream may include ammonium hydroxide for simultaneous particle and organic removal, another chemical to raise the pH of the solution, or other chemical additives designed to accomplish one or more specific cleaning steps.

U.S. Pat. No. 6,817,369 issued in 2004 to Thomas Riedel, et al., relates to a device for cleaning substrates, especially semiconductor wafers and comprises a treatment basin for receiving at least one substrate, a cover for sealing said treatment basin, a first feeding device for controllably feeding in a reactive gas, a second feeding device for controllably feeding in at least one moist fluid for promoting a reaction between the reactive gas and a deposit to be removed from the substrate, and a control device for controlling the concentration of moisture in the treatment basin. The apparatus provides a closed system and enables precise control of the concentration of moisture in the treatment tank. Moisture concentration can be adapted to the respective cleaning process, as a result of which the formation of a liquid layer on the substrates that are to be cleaned by the moisture-containing fluid can be prevented entirely or in a controlled manner. This is important in order to ensure that the reactive gas, or other reactive components, comes into contact with the contaminants or impurities. Furthermore, the ratio of the reactive gas to the fluid can be set in order to provide an optimum cleaning atmosphere and to reduce the consumption of media. The closed system furthermore prevents uncontrolled escape of the reactive gas/fluid mixture.

U.S. Pat. No. 6,848,455 issued in 2005 to Krishnan Shrinivasan, et al. discloses a method and apparatus for removing photoresist and post-etch residue from semiconductor substrates by in-situ generation of oxidizing species. Contaminants are removed from a semiconductor wafer by the in-situ generation of oxidizing species. These active species are generated by the simultaneous application of ultraviolet radiation and chemicals containing oxidants such as hydrogen peroxide and dissolved ozone. Ultrasonic or megasonic agitation is employed to facilitate removal. Radicals are generated in-situ, thus generating them close to the semiconductor substrate. The process chamber has a means of introducing both gaseous and liquid reagents, through a gas inlet, and a liquid inlet. O₂, O₃, and H₂O vapor gases are introduced through the gas inlet. H₂O and H₂O₂ liquids are introduced through the liquid inlet. Other liquids such as ammonium hydroxide (NH₄OH), hydrochloric acid (HCl), hydrofluoric acid (HF), and the like, may be introduced to further constitute those elements of the traditional RCA cleaning. The chemicals are premixed in a desired ratio and to a predetermined level of dilution prior to being introduced into the chamber. The chamber is equipped with a megasonic or ultrasonic transducer probe placed in close proximity to the substrate as the substrate rotates with the rotating platen.

U.S. Pat. No. 6,799,583 issued in 2004 to Saraj Puri, et al. discloses a method of cleaning a surface of an article using cleaning liquids in combination with acoustic energy. Preferably, an ultradiluted concentration of a cleaning enhancement substance, such as ammonia gas, is dissolved in a liquid solvent, such as filtered deionized water, to form a cleaning liquid. The cleaning liquid is caused to contact the surface to be cleaned. Acoustic energy is applied to the liquid during such contact. Optionally, the surface to be cleaned can be oxidized, e.g., by ozonated water, prior to cleaning.

U.S. Pat. No. 6,743,301 issued in 2004 to Kousaku Matsun, et al. discloses a substrate treatment process for removing organic matter from a substrate such as a wafer, glass substrate or ceramic. The process comprises treating the substrate with ozone water and then with hydrogen water, treating the substrate with ozone-hydrogen wate, or treating the substrate with ozone water and hydrogen water at the same time.

U.S. Pat. No. 6,715,944 issued in 2004 to Izumi Oya, et al. discloses an apparatus for removing a photoresist film. The apparatus includes a substrate cassette for fixing a substrate having a surface covered with a photoresist film, an ozone feed tube for supplying ozone, a liquid feed tube for supplying a liquid photoresist film removing solution, and a processing tank for recovering and processing at least the ozone or the liquid photoresist film removing solution, wherein the liquid photoresist film removing solution is supplied through the liquid feed tube as a liquid or mist, at least the ozone or the photoresist film removing solution being continuously supplied.

U.S. Pat. No. 6,616,773 issued in 2003 to Masaki Kuzumoto, et al., discloses a substrate treatment assembly for treating a work object on the surface of a substrate by supplying to the work object a wet ozone-containing gas wetted with a treatment solution. The apparatus includes a substrate heating device for maintaining a substrate at a temperature higher than room temperature, a wetting device for producing a wet ozone-containing gas by wetting an ozone-containing gas with a treatment solution, a supply device for supplying the wet ozone-containing gas to a work object on the surface of the substrate, a gas conduit connecting the wetting device to the supply device, and a heating device for heating the wet ozone-containing gas to a temperature approximately equal to or greater than the temperature of the substrate.

U.S. Pat. No. 6,632,281 issued in 2003 to Jun'ichi Kitano, et al. discloses a substrate processing apparatus and substrate processing method. On top of respective areas divided by partition plates, that is, a cassette station, a processing station, and an interface section in a coating and developing processing system, gas supply sections are provided for supplying an inert gas into the respective areas. Exhaust pipes for exhausting the atmospheres in the respective areas are provided at the bottom of the respective areas. The atmospheres in the respective areas are maintained in a clean condition by supplying the inert gas (not containing impurities such as oxygen and fine particles) from the respective gas supply sections into the respective areas and exhausting the atmospheres in the respective areas from the exhaust pipes.

U.S. Pat. No. 6,699,330 issued in 2004 to Hisashi Muraoka discloses a method of removing surface-deposited contaminants that comprises bringing an ozone-containing treating solution into contact with the surface of a target on which contaminants have been deposited. The ozone-containing treating solution comprises an organic solvent having a partition coefficient to ozone in a gas, of 0.6 or more, and ozone having been dissolved in the solvent. Contaminants having been deposited on the surfaces of various articles including substrates for electronic devices, such as semiconductor substrates and substrates for liquid crystal display devices can be safety and a good efficiently removed by room-temperature and short-time treatment.

U.S. Pat. No. 6,638,365 issued in 2003 to Jianhui Ye, et al., discloses a method of preparing a silicon surface for subsequent processing by thermal oxidation, or metal silicide formation, via the use of a novel wet chemical clean procedure. The novel wet chemical clean procedure is comprised of three specific stages, with the first stage featuring the removal of organic contaminants and the growth of a native oxide layer on the silicon surface. A second stage features removal of the native oxide layer and removal of metallic contaminants from the silicon surface, while the third stage is used to dry the silicon surface. The novel wet chemical clean procedure is performed in less time, and using fewer chemicals, and then counterpart wet chemical cleaning is also used for the preparation of silicon surfaces for subsequent processing steps.

US Patent Application Publication 2002/0033186 filed in 2002 by Srwvwn Verhaverbeke, et al., discloses a process for treating an electronic component wherein the electronic component is exposed to a heated solvent and is subsequently exposed to an ozonated process fluid. The electronic component is optionally exposed to the heated solvent by exposing the electronic component to a passing layer of a heated solvent. Also provided is an apparatus for treating electronic components with a heated solvent and an ozonated process fluid.

It is important to note U.S. Pat. No. 5,911,837 issued in 1999 to Robert Matthews that relates to a process for treatment of semiconductor waters in fluids. The invention is aimed at the removal of organic materials from semiconductor wafers and to a process for drying the wafers by a chemical solvent. In order to obtain a sufficiently high ozone concentration in the deionized water, the bath typically is maintained at about 1 to about 15° C. Below about 1° C., ice may form in the tank. Since these semiconductor process tanks are typically made from quartz, the ice may cause the quartz to break and prohibit movement of silicon wafers into and out of the process vessel. In addition, the system will not function since the water has changed physical states from a liquid to a solid and cannot absorb gases uniformly. Above 15° C., a sufficient amount of ozone may not be absorbed into the deionized water to remove the organic material on the semiconductor wafers in a timely fashion. In a preferred embodiment, the bath is about 5° C. to about 9° C. Generally, the ozone will be diffused into the deionized water for about 1 to about 15 minutes. In a preferred embodiment, the ozone is diffused into the deionized water for about 5 to about 10 minutes.

The wafers are maintained in a stationary state in a tank that contains chilled ozonated water or are placed into a tank of deionized water, and ozone is then diffused into the tank. The amount of time needed for diffusion of the ozone into the water will depend on the nature of the organic material being removed and the amount of that material. The specific temperature of the water bath will also affect the time for diffusion of ozone since the amount of absorption of ozone into the water is dependent on the temperature, and the oxidation power of the water solution is dependent on the amount of ozone absorbed.

However, the system described in U.S. Pat. No. 5,911,837 is low efficient since the wafers are stationary and since in reality the process of dissolving ozone in deionized water may take not only 5 to 10 min., as stated in the above patent but a much longer time. Furthermore, experience has shown that rate of removing inorganic substances with ozone depends more on the concentration of ozone (O₃) in liquid than on the temperature of the solution.

The use of ozone for removing inorganic components of contaminants is also known, e.g., from the article by Dae-Hong Eom, et al., entitled “Reaction of Ozone and H₂O₂ in MH₄OH Solutions and Their Reaction with Silicon Wafers” published in Japanese Journal of Applied Physics, Vol. 43, No. 6A, 2004. It has been shown that when particles of Al₂O₃ were deposited on silicon wafers, the use of ozonated NH₄OH in combination with the application of megatronic power could remove more than 90% of the particles from the wafer surface at room temperature.

The process is difficult to utilize in practice since, at room temperatures, the life of ozone in a solution will be very short, e.g., as mentioned in the article, the half-life of ozone at room temperature was 2 to 5 min.

Thus, the disadvantage of all above-described ozone-based substrate cleaning systems as well as other ozone-based cleaning systems known to the applicant is that they are efficient only in removing organic contaminants or films and are unsuitable for mechanical removal of inorganic contaminants such as carbon dioxide, ammonia, helium, krypton, argon, and nitrous oxide.

### SUMMARY AND OBJECTS OF THE INVENTION

It is an object of the invention to provide an ozone-based method and apparatus for cleaning flat objects such as semiconductor substrates that are equally efficient in removing organic and inorganic substances from the surfaces of the flat objects. It is another object to provide the method and apparatus of the aforementioned type that combines advantages of mechanical wet pulse-jet cleaning systems for removal of inorganic substances with the advantages of the wet chemical ozone-based system for removal of organic substances. Still another object is to provide a universal and adjustable apparatus for cleaning semiconductor substrates or other flat objects from various contaminants that may accumulate on their surfaces. A further object is to provide a method and system of the aforementioned type where the efficiency of removing organic substances is further improved due to the use of a pulsed jet of a cleaning liquid that contains ozone in a pure gaseous state and in a dissolved state.

The present invention is based on the applicant's finding that incorporation of ozone into a cold-water solution injected onto the surface of a treated object in a pulse-jet mode produces a synergistic effect of mechanical removal of inorganic particles and chemical removal of organic contaminants. This effect is greater than just a mere sum of separately used ozone-based cleaning and jet-pulse cleaning. The effect is greater because in a pulsed jet of liquid, ozone can be delivered to the treated object not only in a dissolved state, but it can also be decomposed under the effect of turbulent flow and thereby changed into a gaseous phase that is delivered to the treated surface, i.e., to organic contaminants, in a gaseous phase prior to oxidation. According to the invention, the ozonated pulse-jet treatment is enhanced by utilizing three different consequent cleaning pulses that are cyclically repeated during the cleaning operation. The first pulse is treating the object surface with a jet of an ozone solution, e.g., in a deionized water. Since ozone solution is ejected at a low temperature of about 5° C., and, in order to level the temperature by raising it to about 100° C. prior to the third high-temperature pulse, the second pulse consists of treating the surface with a hot inert gas, e.g., nitrogen. Since gas has a lower thermal capacity than liquid, this pulse has a longer duration than that of the jet-treatment pulse. The third pulse is treatment of the object surface with a mixture of overheated steam and water, e.g., a steam-and-water mixture, at a temperature in the range of 105° C. to 250° C., preferably about 200° C. When the hot steam-and-water mixture exits the cleaning nozzle, because of a sudden increase in volume, it is subject to adiabatic expansion. This process enhances breaking of the stream into small droplets required for efficient cleaning.

The apparatus of the invention comprises a heat-insulated casing that contains an ozone solution container connected to a water-supply source and an ozone generator. The ozone in the container is cooled by means of a cooling coil with a cooling liquid circulating through the coil. Temperature in the ozone solution container is maintained, e.g., in the range of 3° C. to 10° C., preferably, at about 5° C., with the use of a thermostat. From the container, the ozone solution is pumped by a pump with a controller to a nozzle of the cleaning mechanism which ejects the flow in a jet-pulsed mode controlled from a central processing unit onto the surface to be treated. The apparatus is also equipped with a solution heater, heater/mixer controller, etc. The apparatus is provided with three closely arranged independent systems connected to the central processing units and equipped with respective heaters, pumps with controllers, and nozzles for supplying different cleaning solutions to the nozzles of all three types.

The mechanical part of the cleaning unit of the invention may be the same in the earlier patent application of the same applicant (Ser. No. 269,250, filed on Nov. 9, 2005 and entitled “METHOD AND APPARATUS FOR CLEANING FLAT OBJECTS WITH PULSED LIQUID JET”).

An apparatus is enclosed in a sealed and filtered cabinet or enclosure that may be comprised of a class-1 self-powered ULPA-filter cabinet. The cleaning unit contains circumferentially arranged rollers, one of which is a driving roller; the remaining rollers are idler rollers. The drive roller is driven from an adjustable-speed motor. The drive roller and idler rollers are arranged in such a way that there is always a minimal radial or edge contact and no surface contact along the front or backside of the wafer W during processing/cleaning. The rapid-pulse clean unit includes the head assembly that holds the drive and idler rollers. The roller mechanism is mounted with the rollers of different diameters to hold semiconductor wafers of varying sizes from 75 mm to 300 mm and above. The upper part of the head assembly is moveable in a vertical direction on guides to provide insertion of the wafer W. The chamber also contains stationary arrays of the aforementioned ozonated solution pulse nozzles, hot gas nozzles, and overheated steam-and-water mixture nozzles positioned on both sides of the vertical wafer W diametrically across the wafer W to clean the front and back surfaces of the wafer in a simultaneous process.

The droplet formation enhancement means are located inside the ozonated solution nozzles at the nozzle outlet end and are made in the form of a jet splitter, threaded grooves on the inner surfaces of the nozzle bodies, or in the form of a thin tube for the supply of gas into the flow of the liquid cleaning medium for the formation of gas bubbles in the medium. The method also takes into account such factors as a mass ratio between the droplets and the contaminant particles, velocity of droplets, organization and sequence of jets that attack the surface of the wafer, and flows that wash-out the separated particles, etc.

### BRIEF DESCRIPTION OF THE DRAWINGS

FIG. 1 is a graph that shows the effect of temperature on delution of ozone in water.

FIG. 2A is a block-diagram of the ozonated cleaning solution sub-system.

FIG. 2B is a block-diagram of the steam-and-water cleaning sub-system.

FIG. 2C is a block diagram of the overheated-gas cleaning sub-system.

FIG. 2D is a block diagram of the deionized water sub-system.

FIG. 3A is a working diagram of the apparatus of the invention that shows the sequence of pulses during pulsed cleaning of a flat object with an ozonated solution, hot gas, and steam-and-water mixture.

FIG. 3B is a working diagram of the apparatus of the invention that shows the sequence of pulses during pulsed cleaning of a flat object only with an ozonated solution.

FIG. 3C is a working diagram of the apparatus of the invention that shows the sequence of pulses during pulsed cleaning of a flat object with an ozonated solution and hot gas.

FIG. 3D is a working diagram of the apparatus of the invention that shows the sequence of pulses during pulsed cleaning of a flat object with an ozonated solution and deionized water.

FIG. 4 is a three-dimensional view of the nozzle unit of the apparatus of the invention.

FIG. 5 is a view that shows the arrangement of nozzles in the stationary nozzle unit of FIG. 4

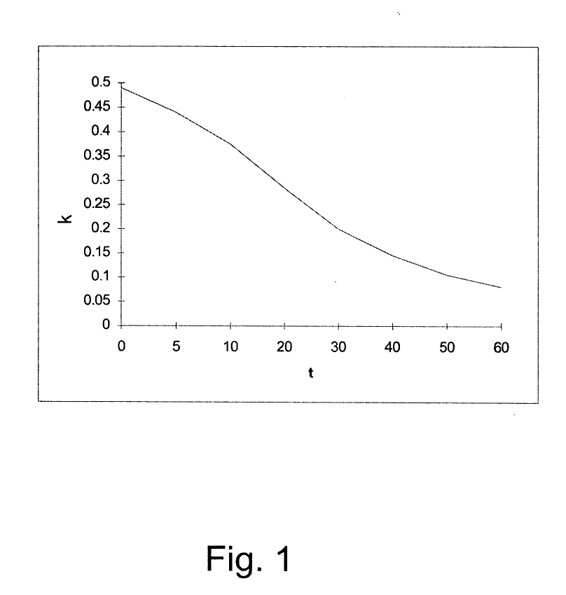

### DETAILED DESCRIPTION OF THE INVENTION

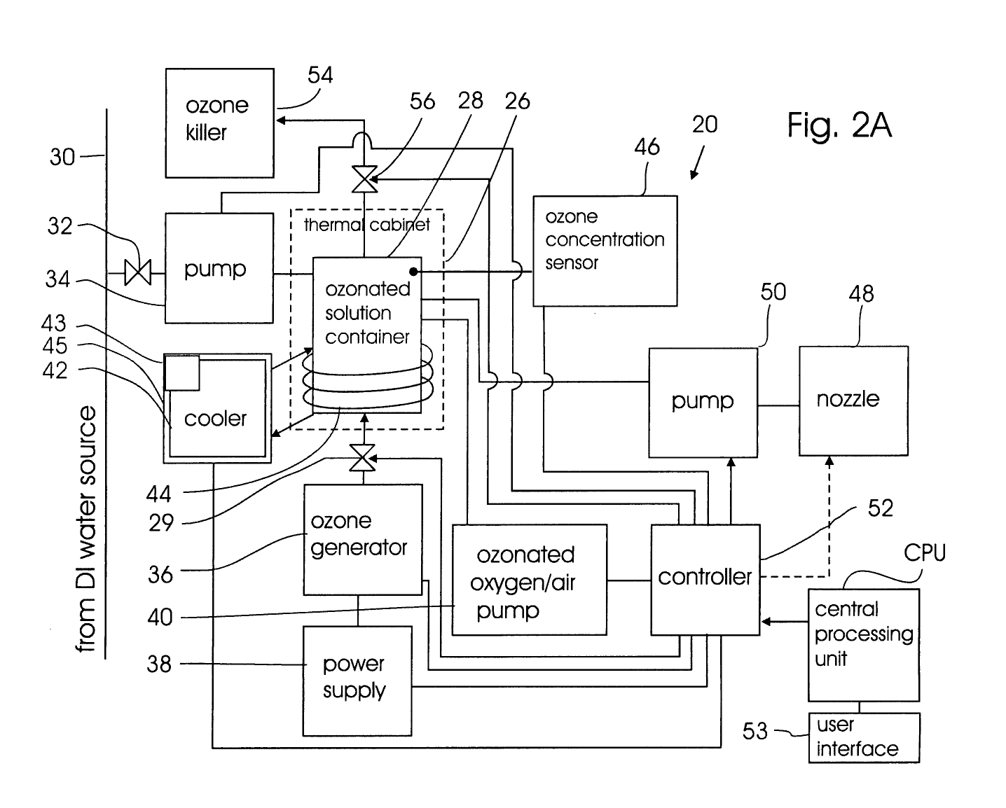

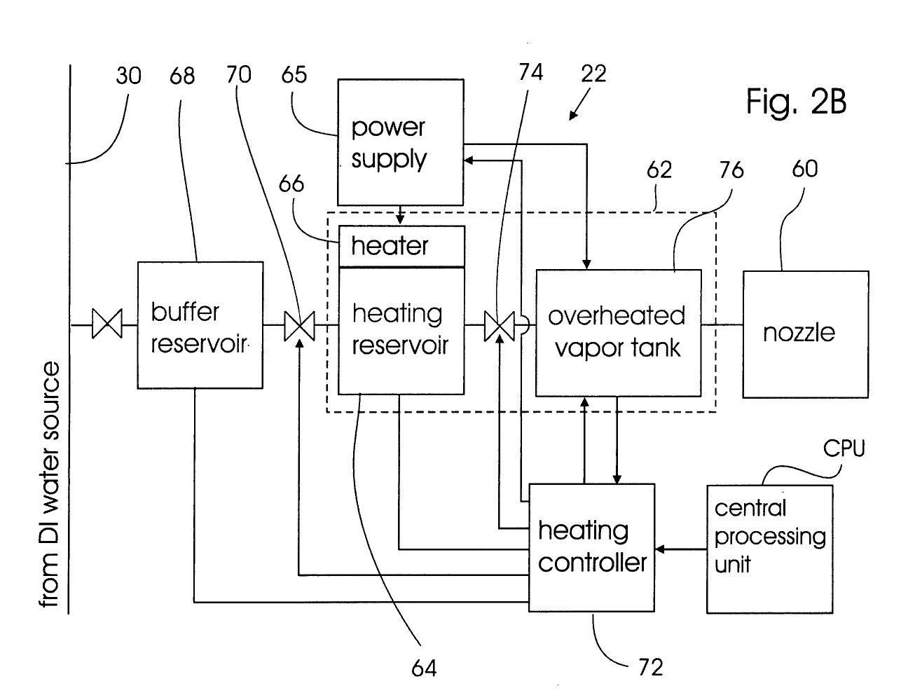

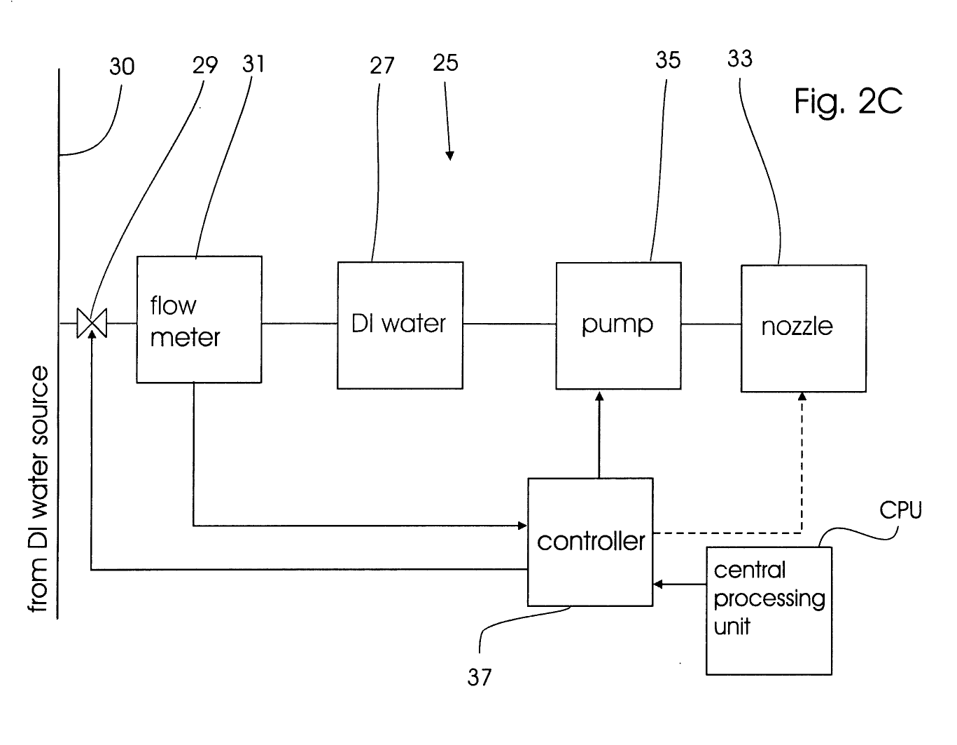

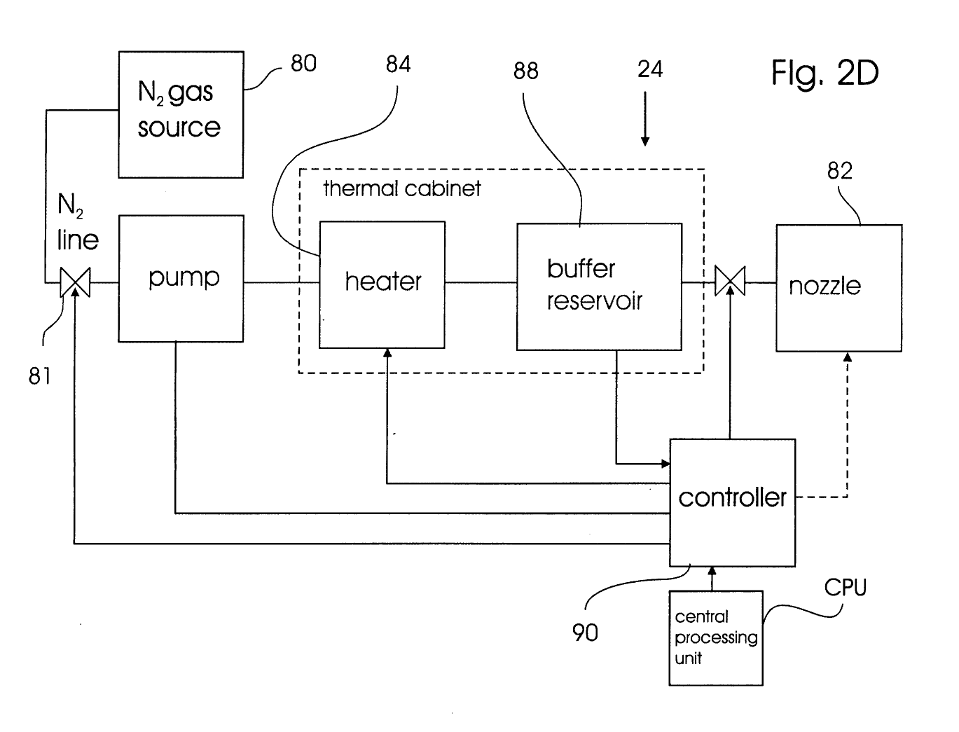

The apparatus consists of three main sub-systems, which will be considered separately in sequence, i.e., an ozonated cleaning solution sub-system 20 shown in block-diagram form in FIG. 2A, a steam-and-water cleaning sub-system 22 shown in block-diagram form in FIG. 2B, and an overheated-gas cleaning sub-system 24 shown in block-diagram form in FIG. 2C. Optionally, the apparatus may also include a deionized water sub-system 25, shown in FIG. 2D. The exit of each sub-system is comprised of an appropriate jet nozzle that impinges the surface of a vertically oriented object, e.g., a semiconductor wafer (not shown) with a stream of fluid emitted from the sub-system. The structure and arrangement of the nozzle unit will be described later.

As shown in FIG. 2A, the ozonated cleaning solution sub-system 20 of the apparatus of the invention is used for cleaning flat objects, such as semiconductor wafers with pulsed jets of the ozonated cleaning liquid. The sub-system 20 is equipped with an ozonated solution container 28, which is enclosed in a heat-insulating cabinet 26, and is connected to a deionized water supply line 30 via a shut-off valve 32 and a pump 34 that pumps the deionized water to the container 28. Connected to the container 28 via a shut-off valve 29 is an ozone generator 36 that is powered by a power supply unit 38. The ozone generator 36 may comprise an appropriate commercially produced unit, such as, e.g., ASTeX® model, that can be obtained from MKS Instruments, MA, USA.

In order to intensify ozonation of the cleaning liquid, the ozonated solution container 28 is connected to an ozonated oxygen/air pump 40 that is used for bubbling of the cleaning liquid simultaneously with the supply of gaseous ozone (O₃). The ozone solution container 28 is cooled by means of a cooler 42 with a pump 43, a thermostat 45, and cooling coil 44 wound around the outer periphery of the container 28. The ozonated cleaning liquid in the container 28 is maintained at a level such that at the exit from the nozzle, the temperature of the solution is maintained in the range of 3° C. to 10° C., preferably, at about 5° C. Since cleaning efficiency to a great extent depends on the concentration of ozone in the cleaning liquid, the sub-system 20 is equipped with an ozone-concentration sensor 46 immersed into the ozonated solution of the container 28. The ozonated solution container 28 is connected to a jet-pulse nozzle 48 via a pump 50 with a controller 52 that is connected to a central processing unit (CPU). Connected to the CPU is a user interface 53. The liquid is emitted from the nozzle 48 in a pulsed mode.

Since release of ozone wastes to the atmosphere is restricted, the sub-system 20 can be equipped with an ozone killer 54 connected to the container 28 via a safety valve 56. The ozone killer changes the detrimental ozone gas into oxygen through a catalyst, such as active charcoal, or the like.

The steam-and-water cleaning sub-system 22 shown in FIG. 2B is intended for generating a high-temperature steam jet through a nozzle 60 of this sub-system for efficiently cleaning the surface of the flat object with droplets of a steam-and-water mixture. A thermally insulating casing 62 of this sub-system encloses a water-heating reservoir 64 with a water heater 66. The reservoir 64 is connected to the deionized water line 30 through a buffer reservoir 68 and a check valve 70. The heater 66 of the water-heating reservoir 64 is connected to a heater power supply unit 65 which, in turn, is connected to the CPU via a heater controller 72. The water heating reservoir 64 is connected to the nozzle 60 through a steam-and-water mixture pressure regulator 74 and an overheated vapor tank 76 which also is enclosed in the thermally insulating casing 62. The heater controller 72 is connected to the steam-and-water mixture pressure regulator 74.

The optional deionized-water sub-system 25, which is shown in FIG. 2C, may consist of a deionized water reservoir 27, the input side of which is connected to the deionized water line 30 via a shut-off valve 29 and a flow meter 31, and the output side of which is connected to a deionized water nozzle 33 via a pump 35. The flow meter 31 and the pump 35 are also connected to a controller 37 that is connected to the CPU. This sub-unit is intended for washing out the chemicals, etc., from the surface of the object with clean deionzied water.

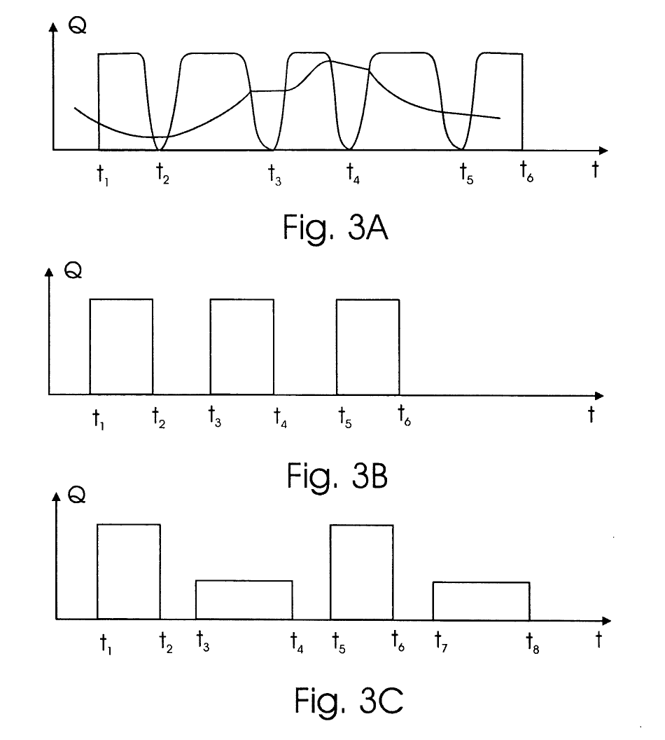

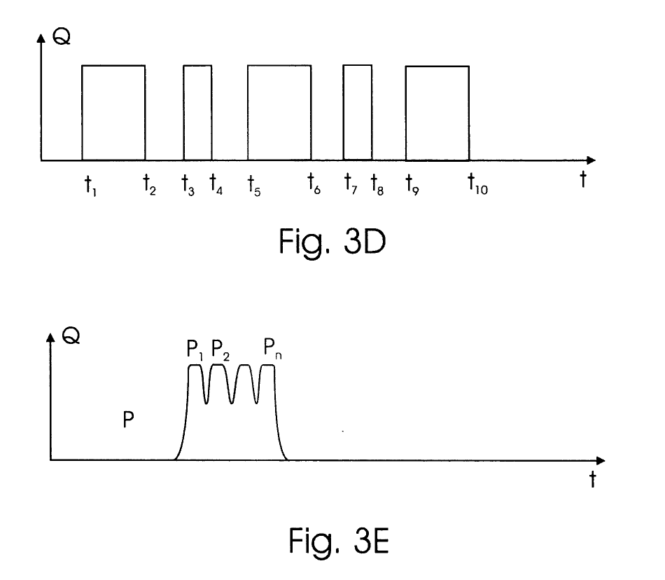

The hot-gas sub-system 24 shown in FIG. 2D is intended for protecting a delicate object such as a precision semiconductor wafer from deterioration because of temperature differences between the deionized water cleaning pulse where the object is treated with an ozonated solution of 5° C. and overheated steam-cleaning pulse where the object is treated with an overheated steam at a temperature in the range of 105° C. to 250° C., preferably about 200° C. The sub-system 24 consists of a source 80 of inert gas, e.g., nitrogen, from where the gas is pumped by a pump 82 through a valve 81 to a gas heater 84 and then via a buffer reservoir 88 to a hot-gas nozzle 82. The buffer reservoir 88 is connected to a controller 90. The controller 90 is connected to the CPU that controls operation of the sub-system 24 via the controller 90 in such a manner that the hot gas, which is heated to a temperature in the range of 70° C. to 150° C., preferably about 100° C., is emitted from the nozzle 84 in a pulsed form, e.g., as shown in FIG. 3A by the pulse between points t2 and t3. It can be seen that during this pulse, which is longer than the pulse from t1 to t2 (since gas has a lower heat-exchange capacity than liquid), the temperature on the surface of the object increases in the transition stage between the cold ozonated liquid and the overheated steam pulse that occurs between points t3 and t4 (FIG. 3A). During the overheated steam pulse, the surface of the object is heated from 100° C. (obtained during the preceding hot gas pulse) to about 200° C.

The apparatus of the invention makes it possible to combine types of cleaning pulses and their sequences. For example, FIG. 3B shows the sequence of pulses during pulsed cleaning of a flat object only with an ozonated solution. In this graph, pulses of the cold ozonated solution correspond to time intervals t1-t2, t3-t4, t5-t6, etc.

FIG. 3C is a working diagram of the apparatus of the invention that shows the sequence of pulses during pulsed cleaning of a flat object with an ozonated solution and hot gas. In this graph, time intervals t1-t2 and t5-t6 correspond to pulses of the cold ozonated solution, and time intervals t3-t4, t7-t8 correspond to pulses of hot gas.

FIG. 3D is a working diagram of the apparatus of the invention that shows the sequence of pulses during pulsed cleaning of a flat object with an ozonated solution and a deionized water. In this graph, time intervals t1-t2 and t5-t6 correspond to pulses of the cold ozonated solution, and time intervals t3-t4 and t7-t8 correspond to pulses of deionized water.

Combinations and sequences of pulses are not limited by the above examples and other combinations are possible, e.g., 1) cold ozonated solution→hot gas→overheated; steam; 2) cold ozonated solution→dionized water→overheated steam; etc.

The pulses may have different shapes, e.g., as shown in FIG. 3E, each individual pulse may be modulated as shown, e.g., in the form of a plurality of short sub-pulses p1, p2, . . . Pn with an amplitude smaller than the amplitude of the basic pulse P.

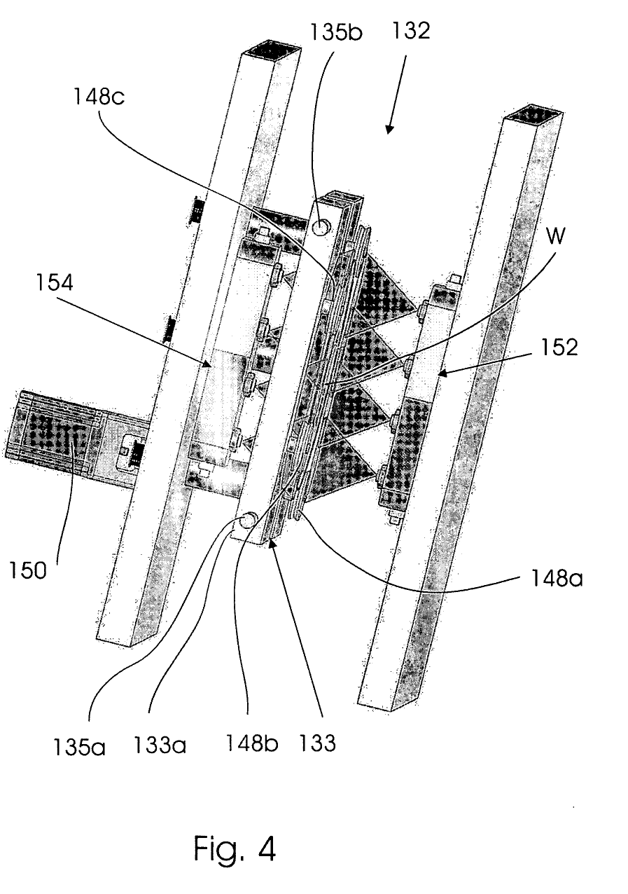

A three-dimensional view of the nozzle unit 132 of the apparatus is shown in FIG. 4. The unit is normally enclosed in a sealed and filtered cabinet or enclosure (not shown) that may be comprised of a class 1 self-powered ULPA-filter cabinet. The cleaning unit 132 contains circumferentially arranged rollers 148a, 148b, 148c . . . , of which the roller 148a is a driving roller and the remaining rollers 148b, 148c, . . . are idler rollers. The drive roller 148a is driven from an adjustable-speed motor 150. The drive roller 148a and idler rollers 148b, 148c, . . . are arranged in so that there is always a minimal radial or edge contact and no surface contact along the front or backside of the wafer W during processing/cleaning. The rapid-pulse clean unit 132 includes the head assembly 133 that holds the drive and idler rollers. The roller mechanism is equipped with rollers of different diameters to hold semiconductor wafers of varying sizes from 75 mm to 300 mm and above. The upper part 133a of the head assembly is moveable in a vertical direction on guides 135a and 135b to provide insertion of the wafer W.

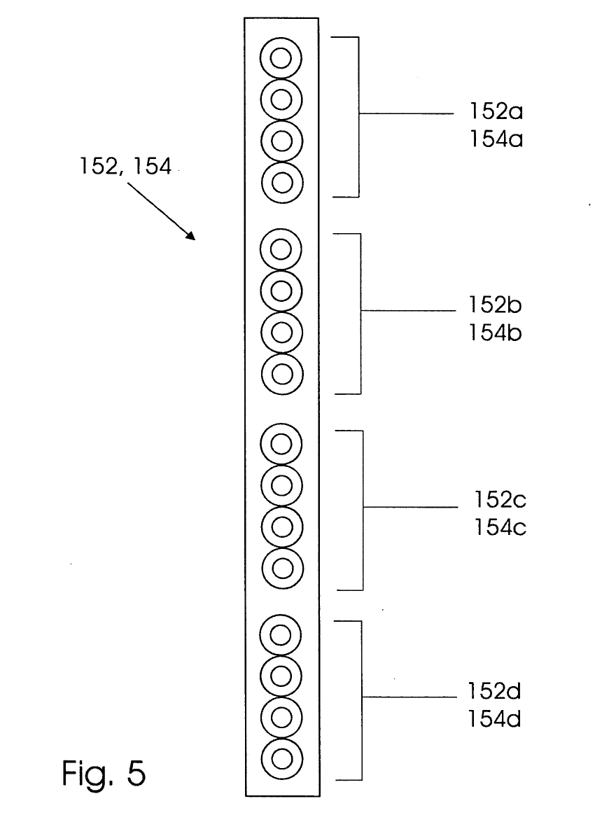

The apparatus also contains stationary nozzle arrays 152 and 154 positioned on both sides of the vertical wafer W diametrically across the wafer W to clean the front and back surfaces of the wafer in a simultaneous process. The arrangement of the stationary nozzle arrays 152 and 154 is shown in FIG. 5. In the illustrated embodiment, each of the nozzle arrays contains four nozzle sets. Thus the nozzle array 152 contains nozzle sets 152a, 152b, 152c, and 152d, while the nozzle array 154 contains nozzle sets 154a, 154b, 154c, and 154d.

As shown in FIG. 5, which is a front view of the nozzle array 150 in the direction of arrow A in FIG. 4, each nozzle set consists of four nozzles, of which the deionized water nozzle is optional. Thus, the nozzle set 152a consists of an ozonated solution nozzle 152a1, a hot-gas nozzle 152a2, a steam-and-water nozzle 152a3, and, if necessary, a deionized water nozzle 152a4. The nozzle set 152b consists of an ozonated solution nozzle 152b1, a hot-gas nozzle 152b2, a steam-and-water nozzle 152b3, and if necessary, a deionized water nozzle 152b4; the nozzle set 152c consists of an ozonated solution nozzle 152c1, a hot-gas nozzle 152c2, a steam-and-water nozzle 152c3, and if necessary, a deionized water nozzle 153c4; and the nozzle set 152d consists of an ozonated solution nozzle 152d1, a hot-gas nozzle 152d2, a steam-and-water nozzle 152d3, and if necessary, a deionized water nozzle 152d4.

The nozzles operate in so-called rapid-pulse harmonic spray modes of the type shown in FIGS. 3A to 3D. In this mode, the ozonated solution nozzle 152a1, 152b1, 152c1, and 152d1 inject discrete droplets of pulsed ozonated solution having specific size selected to match a specific application. The nozzles of this set may have droplet-formation mechanisms of different types, e.g., a slit-like mechanism or a helical groove formed on the inner surface of the nozzle, as described in earlier U.S. patent application Ser. No. 299,134 of Dec. 12, 2005 of the same applicant.

Similarly, the hot-gas nozzles 152a2, 152b2, 152c2, and 152d2 emit onto the surface of the treated object W jets of hot gas at a temperature of about 100° C., while nozzles 152a3, 152b3, 152c3, and 152d3 impinge the surface of the object with jets of a steam-and-water mixture at a temperature of about 200° C.

Thus, it has been shown that the invention provides an ozone-based method and apparatus for cleaning flat objects such as semiconductor substrates that are equally efficient in removing organic and inorganic substances from the surfaces of the flat objects, that combine the advantages of mechanical wet pulse-jet cleaning systems for removal of inorganic substances with the advantages of the wet chemical ozone-based system for removal of organic substances. The invention provides a universal and adjustable apparatus for cleaning semiconductor substrates or other flat objects from various contaminants that may accumulate on their surfaces. Efficiency of removal of organic substances is further improved due to the use of a pulsed jet of a cleaning liquid that contains ozone in a pure gaseous state and in a dissolved state.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, pulses may have a substantially rectangular shape, sinusoidal shape, trapezoidal shape, etc. Ozone may be dissolved not only in a deionized water but also in ultrapure water. The nozzles may have arrangements different from those shown in FIG. 5 and may have different constructions. Control of pulses (duration, frequency, etc.) may be performed via valves controlled by associated controllers or by adjusting the pulse pumps. Combinations and sequences of pulses are not limited by the above examples and other combinations are possible, e.g., 1) cold ozonated solution→hot gas→overheated steam; 2) cold ozonated solution→ionized water→overheated steam; etc.

1. A method for ozone-enhanced cleaning of flat objects with a pulsed liquid jet comprising the steps of:
providing a pulsed liquid jet cleaning apparatus comprising a source of an ozonated solution of a cleaning liquid, at least one ozonated solution nozzle for emitting said ozonated solution of a cleaning liquid, and means for delivering said ozonated solution of a cleaning liquid from said source of an ozonated solution of a cleaning liquid to said at least one ozonated solution nozzle in a pulsed form;
arranging a flat object to be cleaned in front of said at least one nozzle in a vertical position; and
impinging the surface of said flat object with a pulsed jet of said cleaning liquid through said at least one nozzle in the form of ozonated cleaning solution pulses.

2. The method of claim 1, wherein said ozonated cleaning solution is cooled to a degree such that the temperature thereof at the exit from said nozzle is maintained in the range of +3° C. to +10° C.

3. The method of claim 2, wherein said pulsed liquid jet cleaning apparatus further comprising a source of an overheated cleaning steam-and-water mixture, an overheated cleaning steam-and-water mixture nozzle, and means for delivery an overheated steam-and-water mixture from said source of an overheated cleaning steam-and-water mixture to said overheated cleaning steam-and-water mixture nozzle in the form of overheated cleaning steam-and-water mixture pulses during intervals between said ozonated cleaning solution pulses.

4. The method of claim 3, wherein said overheated cleaning steam-and-water mixture has at the exit of said nozzle a temperature in the range of 105° C. to 250° C.

5. The method of claim 3, wherein said pulsed liquid jet cleaning apparatus further comprising a source of a hot gas, a hot gas nozzle, and means for delivery of said hot gas from said source of hot gas to said hot gas nozzle in the form of hot gas pulses between said ozonated cleaning solution pulses and said overheated steam-and-water mixture pulses, said hot gas having a temperature in the range of 70° C. to 150° C.

6. The method of claim 3, wherein said pulsed liquid jet cleaning apparatus further comprising a source of deionized water, a deionized water nozzle, and means for delivery of said deionized water from said source of deionized water to said deionized water nozzle in the form of hot deionized water pulses between said ozonated cleaning solution pulses and said overheated steam-and-water mixture pulses.

7. A pulsed liquid jet cleaning apparatus comprising: a source of an ozonated solution of a cleaning liquid; at least one ozonated cleaning solution nozzle for emitting said ozonated solution of a cleaning liquid, means for delivering said ozonated solution of a cleaning liquid from said source of an ozonated solution of a cleaning liquid to said at least one ozonated cleaning solution nozzle in a pulsed form; and means for holding a flat object to be cleaned in a vertical position in front of said at least one ozonated cleaning solution nozzle.

8. The pulsed liquid jet cleaning apparatus of claim 7, further comprising means for driving said flat object in a motion relative to said at least one ozonated cleaning solution nozzle.

9. The pulsed liquid jet cleaning apparatus of claim 7, wherein said source of an ozonated solution of a cleaning liquid comprises: a source of water; a container for water; a cooler for cooling said water in said container; an ozone generator for generating a gaseous ozone connected to said container for water; and means for diluting said gaseous ozone in said water; said means for delivering said ozonated solution comprising a first pump capable of operating in a pulsed mode.

10. The pulsed liquid jet cleaning apparatus of claim 9, wherein said cooler cools said ozonated solution of a cleaning liquid to a level that provides the temperature of said ozonated solution of a cleaning liquid at the exit from said at least one ozonated cleaning solution nozzle in the range of +3° C. to +10° C.

11. The pulsed liquid jet cleaning apparatus of claim 9, further comprising a first controller connected to said cooler, said ozone generator, and said first pump for controlling operations thereof.

12. The pulsed liquid jet cleaning apparatus of claim 7, further comprising: a source of an overheated cleaning steam-and-water mixture; an overheated cleaning steam-and-water mixture nozzle; means for delivering an overheated cleaning steam-and-water mixture from said source of the overheated cleaning steam-and-water mixture to said overheated cleaning steam-and-water mixture nozzle; and a second controller connected to said source of the overheated cleaning steam-and-water mixture and to said means for delivering an overheated cleaning steam-and-water mixture to said overheated cleaning steam-and-water mixture nozzle for controlling operation thereof.

13. The pulsed liquid jet cleaning apparatus of claim 12, further comprising means for driving said flat object in a motion relative to said at least one ozonated cleaning solution nozzle.

14. The pulsed liquid jet cleaning apparatus of claim 12, wherein said source of an overheated cleaning steam-and-water mixture comprises a container for said overheated cleaning steam-and-water mixture and a heater for generating said overheated cleaning steam-and-water mixture, said heater heating said overheated cleaning steam-and-water mixture to a level that provide the temperature of said overheated cleaning steam-and-water mixture at said overheated cleaning steam-and-water mixture nozzle in the range of 105° C. to 250° C.

15. The pulsed liquid jet cleaning apparatus of claim 7, further comprising: a source of hot gas; a hot gas nozzle; means for delivering the hot gas from said source of hot gas to said hot gas nozzle at a temperature of said hot gas at the exit from hot gas nozzle in the range of 70° C. to 150° C.; and a third controller connected to said source of hot gas and to said means for delivering the hot gas for controlling operation thereof.

16. The pulsed liquid jet cleaning apparatus of claim 15, further comprising means for driving said flat object in a motion relative to said at least one ozonated cleaning solution nozzle.

17. The pulsed liquid jet cleaning apparatus of claim 7, further comprising: a source of deionized water; a deionized water nozzle; means for delivering the deionized water from said source of deionized water to said deionized water nozzle in a pulsed form; and a fourth controller for controlling operation of said means for delivering the deionized water.

18. A pulsed liquid jet cleaning apparatus comprising:
a source of an ozonated solution of a cleaning liquid;
an ozonated cleaning solution nozzle for emitting said ozonated solution of a cleaning liquid;
means for delivering said ozonated solution of a cleaning liquid from said source of an ozonated solution of a cleaning liquid to said ozonated cleaning solution nozzle in a pulsed form;
a source of an overheated cleaning steam-and-water mixture;
an overheated cleaning steam-and-water mixture nozzle;
means for delivering an overheated cleaning steam-and-water mixture from said source of the overheated cleaning steam-and-water mixture to said overheated cleaning steam-and-water mixture nozzle;
a second controller connected to said source of the overheated cleaning steam-and-water mixture and to said means for delivering an overheated cleaning steam-and-water mixture to said overheated cleaning steam-and-water mixture nozzle for controlling operation thereof;
further comprising: a source of hot gas; a hot gas nozzle; means for delivering the hot gas from said source of hot gas to said hot gas nozzle;
a third controller connected to said source of hot gas and to said means for delivering the hot gas for controlling operation thereof;
a source of hot gas;
a hot gas nozzle;
means for delivering the hot gas from said source of hot gas to said hot gas nozzle;
a third controller connected to said source of hot gas and to said means for delivering the hot gas for controlling operation thereof; and
means for holding a flat object to be cleaned in a vertical position in front of said ozonated cleaning solution nozzle; said hot gas nozzle; and said overheated cleaning steam-and-water mixture nozzle.

19. The pulsed liquid jet cleaning apparatus of claim 18, further comprising: means for driving said flat object in a motion relative to said ozonated cleaning solution nozzle, said hot gas nozzle, and said overheated cleaning steam-and-water mixture nozzle; and a central processing unit connected to said first controller, said second controller, said third controller, and said means for driving.

20. The pulsed liquid jet cleaning apparatus of claim 18, further comprising a source of deionized water; a deionized water nozzle; means for delivering the deionized water from said source of deionized water to said deionized water nozzle in a pulsed form; and a fourth controller for controlling operation of said means for delivering the deionized water.

21. The pulsed liquid jet cleaning apparatus of claim 20, further comprising central processing unit connected to said fourth controller.
